(19) United States
(12) Patent Application Publication
(10) Pub. No.: US 2024/0219267 A1
(43) Pub. Date: Jul. 4, 2024

(54) STRONG-ROBUSTNESS METHOD FOR EXTRACTING EARLY DEGRADATION FEATURES OF SIGNALS AND MONITORING OPERATIONAL STATUS OF DEVICE

(71) Applicant: JIANGSU UNIVERSITY, Zhenjiang (CN)

(72) Inventors: Wei FAN, Zhenjiang (CN); Zhenqiang CHEN, Zhenjiang (CN); Yingqi XU, Zhenjiang (CN); Yujie SHEN, Zhenjiang (CN); Long CHEN, Zhenjiang (CN)

(73) Assignee: JIANGSU UNIVERSITY, Zhenjiang (CN)

(21) Appl. No.: 17/920,053

(22) PCT Filed: Feb. 10, 2022
(86) PCT No.: PCT/CN2022/075862

§ 371 Date: Oct. 20, 2022

(30) Foreign Application Priority Data
Sep. 6, 2021 (CN) 202111046673.7

(51) Int. Cl. G01M 99/00; G01H 1/00

(52) U.S. Cl. CPC G01M 99/005; G01H 1/003

(57) ABSTRACT

A strong-robustness method for extracting early degradation features of signals and monitoring an operational status of a device is provided. Acquired vibration signal data of a rotating mechanical device is grouped at equal time intervals in a chronological order. Compression conversion is performed on the data, a newly defined function is solved, thereby a performance degradation index of the device is obtained. Data of the device in a normal status is obtained by determining an overall trend of an Exponentially Weighted Moving Average (EWMA) statistic, and a control limit for the EWMA statistic is constructed by using the data in the normal status. The calculated performance degradation index of the device is converted into an EWMA statistic, and the EWMA statistic is compared with the control limit. If the EWMA statistic does not fluctuate about a center line or exceeds the control limit, a monitored state is out of control.

### CROSS REFERENCE TO THE RELATED APPLICATIONS

This application is the national phase entry of International Application No. PCT/CN2022/075862, filed on Feb. 10, 2022, which is based upon and claims priority to Chinese Patent Application No. 202111046673.7, filed on Sep. 6, 2021, the entire contents of which are incorporated herein by reference.

### TECHNICAL FIELD

The present disclosure belongs to the field of status monitoring of rotating mechanical devices, and specifically relates to a strong-robustness method for extracting early degradation features of signals and monitoring an operational status of a device.

### BACKGROUND

In the field of industrial device, rotating machinery generally constitutes the main body or other key parts of various mechanical device, and its stability and reliability are the guarantee for the safe operation of the entire device. Once the rotating machinery and its typical parts fail during the operation process, the operation of the entire device may be severely affected, resulting in great economic losses or even major accidents. Therefore, it is of great engineering significance to implement status monitoring and early fault warning of rotating machinery.

In the field of status monitoring of rotating mechanical device, commonly used monitoring methods include a vibration analysis method, a temperature analysis method, an acoustic emission method, etc. Because the vibration signal has a clear physical meaning and can intuitively reflect faults at different parts and of different degrees, the vibration analysis method is frequently used at present.

Signal feature extraction has always been a key step in device status monitoring. A good feature index should be able to accurately and clearly characterize the degradation process of the device. Only based on such a good feature index can accurate status monitoring results be obtained. Time-domain feature extraction technology is a commonly used feature extraction method, and its results are intuitive and easy to understand. Conventional time-domain statistics may be divided into dimensional statistics such as root mean square value and dimensionless statistics such as kurtosis value. Different types of feature indexes have different degrees of sensitivity to different types of fault signals. For example, root mean square values are sensitive to evolving wear faults, and kurtosis values are sensitive to shock-type faults. Considering that fault signals of typical parts such as bearings and gears in rotating machinery are periodic pulse signals, although the kurtosis value and other indexes are also sensitive to periodic pulses, such conventional time-domain indexes cannot well show the performance degradation state of the device when the interference of environmental noise is large and only a tiny fault occurs in the device. Therefore, to solve this problem, the present disclosure proposes a strong-robustness method for extracting early degradation features of signals and monitoring an operational status of a device.

Statistical process control is a method for quantitative analysis of target parameters based on control charts, and is one of the important methods of modern quality management. The implementation of this method mainly includes two steps: The first step is to obtain a control limit based on data generated in an initial process, so as to draw the control limit. The second step is to monitor a subsequent process based on the control limit that has been drawn. However, the conventional Shewhart control chart only focuses on the use of current data to determine whether the sample is under control, and fails to consider the influence of historical data. A fault in rotating mechanical device is a small change for a long time. In view of this, the present disclosure adopts an Exponentially Weighted Moving Average (EWMA) control chart to monitor statistical indexes. This control chart not only takes into consideration different influence of historical data, but also is more sensitive to small displacements.

### SUMMARY

In view of this, the present disclosure provides a strong-robustness method for extracting early degradation features of signals and monitoring an operational status of a device. An objective of the present disclosure is to realize the extraction of degradation features of a rotating mechanical device and the monitoring of the operational status of the rotating mechanical device under strong noise interference.

To achieve the above objective, the present disclosure provides the following technical means.

A strong-robustness method for extracting early degradation features of signals and monitoring an operational status of a device is provided, including the following steps:
step S1: grouping acquired full-life vibration signal data of a rotating mechanical device at equal time intervals in a chronological order to obtain groups of the data, where the groups of the data are defined as sample 1, sample 2, sample 3, . . . , and sample s in sequence, and data recorded in each sample is defined as y(t);
step S2: performing compression conversion on the data in each sample to construct a new periodic signal g_{T}(t),

$${g}_{T} ( t ) = \{ \begin{matrix}\frac{\sqrt{m}}{m} {\sum }_{i = 0}^{m - 1} y ( t + iT ) , 0 \leq t < T \\ {g}_{T} ( t - ⌊ \frac{t}{T} ⌋ T ) , T \leq t \leq Γ\end{matrix} ,$$

where Γ′ is a signal length of the signal y(t), T is a period selected for a new periodic compression function, └a┘ is a round-down operator for obtaining a largest integer smaller than a, m is a quantity of segments divided from the signal, and m=└Γ/T┘;
step S3: for the data in each sample, defining a signal e(t) and a signal r(t) by using the original signal y(t) and the constructed new periodic signal g_{T}(t):

$$\{ \begin{matrix}e ( t ) = {g}_{T} ( t ) + y ( t ) , 0 \leq t < Γ \\ r ( t ) = {g}_{T} ( t ) - y ( t ) , 0 \leq t < Γ\end{matrix} .$$

step S4: calculating a correlation function W(T) based on the defined signal e(t) and signal r(t):

$$W ( T ) = \frac{\frac{1}{mT} {\int }_{0}^{mT} e ( t ) r ( t ) dt}{\sqrt{m - 1}} ,$$

where: T is the period selected for the new periodic compression function, and m is the quantity of segments divided from the signal;
step S5: calculating an average of the functions W(T) calculated according to different sample data, and using the average as a device performance degradation index w*, where the statistical index calculated according to an ith sample is defined as wᵢ*;
step S6: calculating each sample point in a control chart according to a calculation formula of an EWMA statistic: Zᵢ=λ*wᵢ*+(1−λ)Zᵢ₋₁, where, an initial value Z₀ is an average of statistical indexes calculated in a normal status, λ represents an EWMA smoothing coefficient, and λ∈(0,1], and herein λ is 0.4;
step S7: plotting a full sample trend graph by taking a sample serial number as a horizontal axis and the EWMA statistic as a vertical axis, and determining a quantity of samples in the normal status in the device according to the full sample trend graph;
step S8: calculating an upper control limit (UCL), a center line (CL), and a lower control limit (LCL) of the control chart in sequence according to device data in the normal status by using the following formula:

$$UCL = {μ}_{0} + L σ \sqrt{( \frac{λ}{2 - λ} ) ( 1 - {( 1 - λ )}^{2 i} )} ; \\ CL = {μ}_{0} ; LCL = {μ}_{0} + L σ \sqrt{( \frac{λ}{2 - λ} ) ( 1 - {( 1 - λ )}^{2 i} )}$$

where: μ₀ is an average of wᵢ* selected as statistical indexes in the normal status, σ is a standard deviation of wᵢ* selected as the statistical indexes in the normal status, L is a setting parameter of a control limit and is 3 herein, and λ is the EWMA smoothing coefficient;
step S9: monitoring full data by using the upper control limit, the lower control limit, and the center line, plotting a complete control chart, and analyzing the complete control chart according to a control chart judgment criterion to obtain a complete operational status of the device.

Further, a performance of the device is analyzed by calculating a variance of the function W(T) defined in the step S4.

Considering that a vibration signal of the rotating mechanical device acquired in the normal status is ambient environmental noise, and a vibration signal of the rotating mechanical device acquired in a faulty status is a periodic signal submerged in the environmental noise, the acquired vibration signal y(t) of the rotating mechanical device is simulated by adding up a signal x(t) with an unknown period T₀ and a strong Gaussian white noise signal E(t) obeying a normal distribution N(0, σ²).

Finally, it can be calculated that the variance of the function W (T) in the normal status of the device is:

$$Var ( W ) = \frac{2 {σ}^{4}}{mN} ,$$

and the variance of the function W(T) in the faulty status of the device is:

$$Var ( {W}_{d} ) \leq \frac{4 {σ}^{2} ( m - 2 )}{( m - 1 ) N} {P}_{x} ( Γ ) + \frac{4 {σ}^{2}}{( m - 1 ) mN} {P}_{x} ( Γ ) + \frac{2 {σ}^{4}}{mN} ,$$

where, m is the quantity of segments divided from the signal, m=└Γ/T┘, N is a quantity of sample points included in a segment of the signal with the period T, σ is a standard deviation of strong Gaussian white noise, Pₓ(Γ) represents an average energy of the periodic signal x(t), and

$${P}_{x} ( Γ ) = {P}_{x} ( mT ) = \frac{1}{mT} {\int }_{0}^{mT} {x}^{2} ( t ) dt .$$

Equality holds in the inequality if and only if T=kT₀, k=1, 2 . . . └Γ/T₀┘.

It can be found through calculation that the function W (T) has the following properties.
1) When the device is in the normal status, the function value of W(T) fluctuates stably about the average, and due to the existence of the denominator in the variance, ambient environmental noise of the device will not be able to dominate the fluctuation of the function value.
2) When a fault occurs in the device, the function value of W (T) has a peak value when T is equal to an integer multiple of the unknown period T₀, and the peak value increases with a degree of the fault of the device.

Further, by analyzing the statistical index wᵢ* proposed in the step S5, it can be found that this index has the following properties.
1) When the device is in the normal status, the value of this performance degradation index remains stable.
2) When a fault occurs in the device, the value of this performance degradation index exceeds the stable value in the normal status of the device.
3) As the degree of the fault increases, this performance degradation index deviates more than the stable value in the normal status of the device.

Based on the above technical solutions, the present disclosure has the following beneficial technical effects.
1) Even if the rotating mechanical device is in a noisy operating environment and the interference of environmental noise is large, the proposed method for extracting performance degradation features of the mechanical device can still extract the performance degradation indexes with good performance.
2) The use of the EWMA control chart can effectively detect a tiny change in the measured index, so as to quickly and accurately monitor the status of the device and make further fault warnings.

### BRIEF DESCRIPTION OF THE DRAWINGS

FIG. 1 is a schematic flowchart of a strong-robustness method for extracting early degradation features of signals and monitoring an operational status of a device according to the present disclosure.

FIG. 2 shows a complete trend graph of a performance degradation index of a bearing according to an embodiment.

FIG. 3 shows an EWMA control chart according to an embodiment.

FIG. 4 is a graph showing details of an EWMA control chart according to an embodiment.

### DETAILED DESCRIPTION OF THE EMBODIMENTS

To make the objectives, technical solutions, and advantages of the present disclosure clearer, the present disclosure is described in further detail with reference to accompanying drawings and examples. It should be understood that the specific embodiments described herein are merely used for explaining the present disclosure, and are not intended to limit the present disclosure. The present disclosure is achieved through the following technical solutions.

As bearings are typical components in rotating mechanical devices, a bearing is used as a test object in the embodiments.

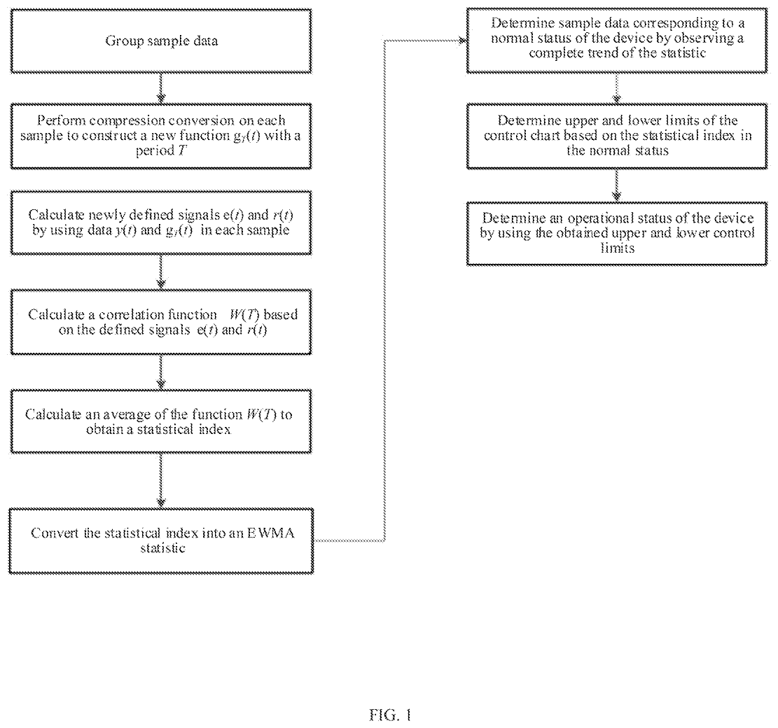

Data comes from the full life test for bearings conducted by the Center for Intelligent Maintenance Systems (IMS), University of Cincinnati, the United States, which records all the data of the bearing from normal operation to failure in a chronological order. In the embodiments, operation data recorded in Test 2 is used, which contains a total of 984 data files, and records complete data of the bearing from 10:32:39, Feb. 12, 2004 to 6:22:39, Feb. 19, 2004 by acquiring a vibration signal once every 10 minutes. As shown in FIG. 1, a strong-robustness method for extracting early degradation features of signals and monitoring an operational status of a device according to an embodiment includes the following steps.
S1: The data is grouped according to the saved file serial numbers, to obtain 984 groups of data
S2: Compression conversion is performed on the 984 groups of data to construct a new function g_{T}(t) with a period T, where

$${g}_{T} ( t ) \{ \begin{matrix}\frac{\sqrt{m}}{m} {\sum }_{i = 0}^{m - 1} y ( t + iT ) , 0 \leq t < T \\ {g}_{T} ( t - ⌊ \frac{t}{T} ⌋ T ) , T \leq t \leq Γ\end{matrix} .$$

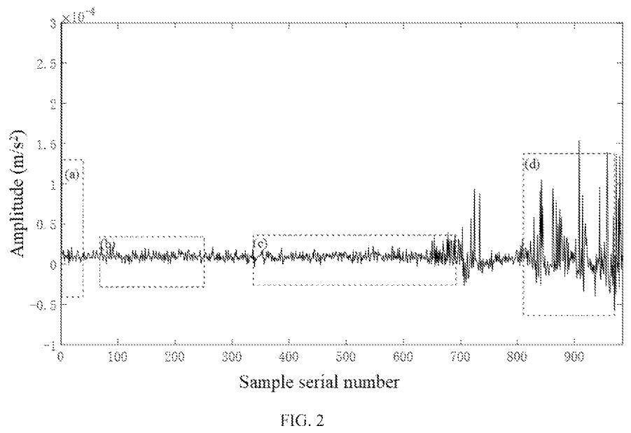

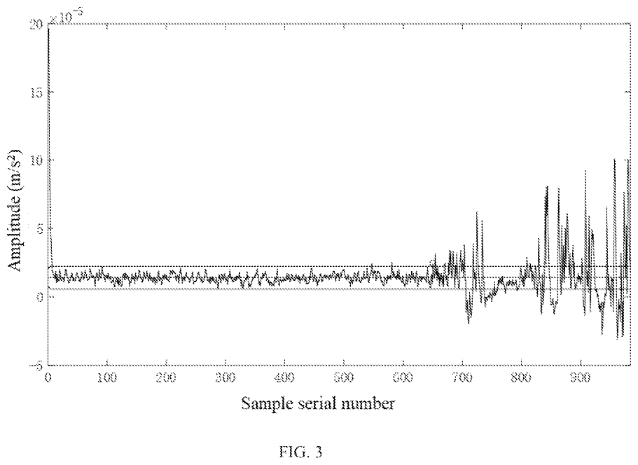

S3: Signals e(t) and r(t) corresponding to the 984 groups of data are respectively calculated by using the constructed new function g_{T}(t), where e(t)=g_{T}(t)+y(t), 0≤t<Γ, and r(t)=g_{T}(t)−y(t), 0≤t<Γ
S4: A correlation function W(T) of each group is calculated based on the signals e(t) and r(t) of different groups, and an average of W(T) is calculated and used as a statistical index w* for characterizing an operational status of the device, where the statistical index calculated according to an ith sample is defined as wᵢ*, where i=1, 2, . . . , 984.
S5: The calculated 984 bearing performance degradation indexes are converted into an EWMA statistic, i.e., Zᵢ=λ*wᵢ*+(1−λ)Zᵢ₋₁, where, λ represents an EWMA smoothing coefficient, and λ∈(0,1]. Herein, λ is 0.4. An initial value Z₀ is an average of statistical indexes calculated in a normal status.
S6: As shown in FIG. 2, a complete trend chart of the EWMA statistical index is plotted. It can be found that an initial part of the EWMA statistic in dashed box (a) exceeds the control limit, which can be understood as the phenomenon caused by the vibration of the test rig when being started. A middle part of the EWMA statistic remains stable, but the starting point of a tiny fault of the bearing cannot be properly determined. Therefore, the first half of the data is taken as much as possible and considered as data in the normal status of the bearing. Herein, data recorded in the 80th to 250th groups in dashed box (b) is considered as the data under normal operation of the bearing, and data recorded in the groups in dashed box (d) is considered as data when an obvious fault occurs in the bearing.
S7: An EWMA control chart for monitoring is plotted, with the result being shown in FIG. 3. It can be clearly found that there is a bearing performance degradation index exceeding the control limit, indicating that a fault has occurred in the bearing at the end of the test, which is consistent with the experimental results.

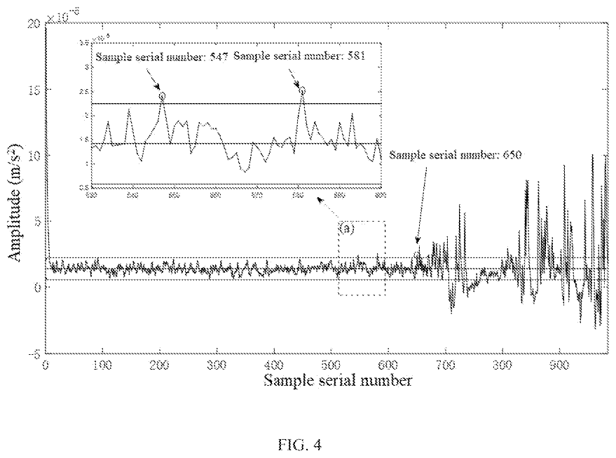

FIG. 4 shows the details of the EWMA control chart, where, the starting point exceeded the control limit, which can be understood as the vibration of the test rig when being started, not the abnormality of the bearing; the EWMA statistics corresponding to the sample serial numbers 547 and 581 exceeded the upper control limit; and starting with the sample serial number 650, the calculated EWMA statistic frequently exceeded the control limit. Therefore, based on a judgment criterion that the entire monitoring process is under control only when the statistical data fluctuates about the center line and does not exceed the control limits, it can be concluded that: the bearing became faulty starting from 5:32:39, Feb. 16, 2004 (sample 547), and the fault of the bearing became significant starting from 22:42:39, Feb. 16, 2004 (sample 650).

To sum up, the strong-robustness method for extracting the early degradation features of the signals and monitoring the operational status of the device of the present disclosure can effectively extract performance degradation indexes of rotating mechanical device and achieve the function of status monitoring, and can be applied to industrial applications.

In the description of the specification, the description with reference to the terms “an embodiment”, “some embodiments”, “exemplary embodiments”, “example”, “specific example”, or “some example” and so on means that specific features, structures, materials or characteristics described in connection with the embodiment or example are embraced in at least one embodiment or example of the present disclosure. In the present specification, the illustrative expression of the above terms is not necessarily referring to the same embodiment or example. Moreover, the described specific features, structures, materials or characteristics may be combined in any suitable manner in one or more embodiments.

Although the embodiments of the present disclosure have been illustrated and described above, it is to be understood by those of ordinary skill in the art that various changes, alterations, replacements and modifications can be made to these embodiments without departing from the principle and spirit of the present disclosure. The scope of the present disclosure is defined by the appended claims and equivalents thereof.

What is claimed is:

1. A strong-robustness method for extracting early degradation features of signals and monitoring an operational status of a device, comprising the following steps:
step S1: grouping a set of full-life vibration signal data of a rotating mechanical device at equal time intervals in a chronological order to obtain groups of the data, wherein the groups of the data are defined as sample 1, sample 2, sample 3, . . . , and sample s in sequence, and data recorded in each sample is defined as y(t), and s represents a last serial number of serial numbers of the samples;
step S2: performing compression conversion on the data in each sample to construct a new periodic signal g_{T}(t),
$${g}_{T} ( t ) \{ \begin{matrix}\frac{\sqrt{m}}{m} {\sum }_{i = 0}^{m - 1} y ( t + iT ) , 0 \leq t < T \\ {g}_{T} ( t - ⌊ \frac{t}{T} ⌋ T ) , T \leq t \leq Γ\end{matrix} ,$$
wherein Γ is a signal length of the signal y(t), T is a period selected for a new periodic compression function, └a┘ is a round-down operator for obtaining a largest integer smaller than a, m is a quantity of segments divided from the signal, and m=└Γ/T┘;
step S3: for the data in each sample, defining a signal e(t) and a signal r(t) by using the original signal y(t) and the constructed new periodic signal g_{T}(t):
$$\{ \begin{matrix}e ( t ) = {g}_{T} ( t ) + y ( t ) , 0 \leq t < Γ \\ r ( t ) = {g}_{T} ( t ) - y ( t ) , 0 \leq t < Γ\end{matrix}$$
step S4: calculating a correlation function W(T) based on the signal e(t) and the signal r(t):
$$W ( T ) = \frac{\frac{1}{mT} {\int }_{0}^{mT} e ( t ) r ( t ) dt}{\sqrt{m - 1}}$$
step S5: calculating an average of the functions W(T) calculated according to different sample data, and using the average as a statistical index w* for characterizing the operational status of the device, wherein the statistical index calculated according to an ith sample is defined as wᵢ*;
step S6: calculating each sample point in a control chart according to a calculation formula of an Exponentially Weighted Moving Average (EWMA) control chart statistic: Zᵢ=λ*wᵢ*+(1−λ)Zᵢ₋₁, wherein an initial value Z₀ is an average of statistical indexes calculated in a normal status, λ represents an EWMA smoothing coefficient, and λ∈(0,1];
step S7: plotting a graph of full sample data by taking a sample serial number as a horizontal axis and the EWMA statistic as a vertical axis, determining a quantity of samples in the normal status in the device according to the graph, and calculating an upper control limit UCL, a lower control limit LCL, and a center line CL of the control chart according to data in the normal status by using the following formula:
$$UCL = {μ}_{0} + L σ \sqrt{( \frac{λ}{2 - λ} ) ( 1 - {( 1 - λ )}^{2 i} )} \\ CL = {μ}_{0} \\ LCL = {μ}_{0} - L σ \sqrt{( \frac{λ}{2 - λ} ) ( 1 - {( 1 - λ )}^{2 i} )}$$
wherein μ₀ is an average of wᵢ* selected as statistical indexes in the normal status, σ is a standard deviation of wᵢ* selected as the statistical indexes in the normal status, L is a setting parameter of a control limit, and λ is the EWMA smoothing coefficient;
step S8: monitoring the EWMA statistic by using the upper control limit, the lower control limit, and the center line, plotting a complete control chart, and analyzing the complete control chart according to a control chart judgment criterion to obtain a complete operational status of the device.

2. The strong-robustness method for extracting the early degradation features of the signals and monitoring the operational status of the device according to claim 1, wherein a variance of the function W(T) defined in the step S4 in the normal status of the device is different from that in a faulty status of the device;
generally a vibration signal of the rotating mechanical device acquired in the normal status is ambient environmental noise, a vibration signal of the rotating mechanical device acquired in the faulty status is a periodic signal submerged in the environmental noise, the acquired vibration signal y(t) of the rotating mechanical device is simulated by adding up a signal x(t) with an unknown period T₀ and a strong Gaussian white noise signal ϵ(t) obeying a normal distribution N(0,σ²);
in the normal status of the device, the variance of the function W (T) is:
$$Var ( W ) = \frac{2 {σ}^{4}}{mN}$$
wherein, m is the quantity of segments divided from the signal, m=└Γ/T┘, N is a quantity of sample points comprised in a segment of the signal with the period T, and σ is a standard deviation of the environmental noise; when an operating environment of the device is determined, σ is constant, mN is constant, and the variance of the function W(T) remains unchanged; due to existence of a denominator, a variance σ² of the environmental noise no longer dominates the variance of the function W(T);
when a fault occurs in the rotating mechanical device, the variance of the function W(T) is:
$$Var ( {W}_{d} ) \leq \frac{4 {σ}^{2} ( m - 2 )}{( m - 1 ) N} {P}_{x} ( Γ ) + \frac{4 {σ}^{2}}{( m - 1 ) mN} {P}_{x} ( Γ ) + \frac{2 {σ}^{4}}{mN}$$
wherein, m is the quantity of segments divided from the signal, m=└Γ/T┘, N is the quantity of sample points comprised in the segment of the signal with the period T, and Γ is the standard deviation of the environmental noise; Pₓ(T) represents an average energy of the periodic signal x(t), and
$${P}_{x} ( Γ ) = {P}_{x} ( mT ) = \frac{1}{mT} {\int }_{0}^{mT} {x}^{2} ( t ) dt ;$$
equality holds in the inequality if and only if T=kT₀, k=1, 2 . . . └Γ/T₀┘; obviously, the average energy Pₓ(T) and the noise variance σ² of a given signal are constant; the average energy Pₓ(Γ) increases with a degree of the fault of the device; the variance of the function W(T) when the fault occurs in the device has a peak value if and only if T is equal to an integer multiple of the unknown period T₀, and the peak value increases with the degree of the fault of the device; due to the existence of the denominator, the variance σ² of the environmental noise no longer dominates the variance of the function W(T).

3. The strong-robustness method for extracting the early degradation features of the signals and monitoring the operational status of the device according to claim 1, wherein a value of the statistical index wᵢ* defined in the step S5 in the normal status of the rotating mechanical device is different from that in a faulty status of the rotating mechanical device, and the value increases with a degree of a fault of the device, so as to realize a function of characterizing the operational status of the device.

4. The strong-robustness method for extracting the early degradation features of the signals and monitoring the operational status of the device according to claim 1, wherein λ is 0.4.

5. The strong-robustness method for extracting the early degradation features of the signals and monitoring the operational status of the device according to claim 1, wherein L is 3.
